(19) United States
(12) Patent Application Publication
(10) Pub. No.: US 2008/0251688 A1
(43) Pub. Date: Oct. 16, 2008

(54) Foldable baking pan

(76) Inventors: Aneela R. Rajusth, Schaumburg, IL (US); Edward Hicks, Sleepy Hollow, IL (US); Marco Pineda, Hanover Park, IL (US); Jeffrey Bazrio, Chicago, IL (US)

Correspondence Address: LAMPEL & ASSOCIATES, P.C., 555 SKOKIE BLVD., SUITE 500, NORTHBROOK, IL, 60062, US

(21) Appl. No.: 11/787,251

(22) Filed: Apr. 16, 2007

(51) Int. Cl. B41B 11/60; B41B 11/58

(52) U.S. Cl. 249/166; 249/169

(57) ABSTRACT

The present invention generally relates to a foldable baking pan which is formed by locking four panels onto a bottom panel. Each of the panels have a grasping portion which mates with a corresponding portion on the underside of the bottom panel. To assemble the pan for use, the grasping portions of the panels and the bottom panel are first mated. The panels are next rotated to an upward position to form the pan. The panels are then locked into place. The assembled pan may then be used for baking or other suitable uses. The pan may be easily disassembled for cleaning and/or storage.

### BACKGROUND OF THE INVENTION

The present invention generally relates to a foldable baking pan which is formed by locking four panels onto a bottom panel. Each of the panels may have a grasping portion which mates with a corresponding portion on the underside of the bottom panel. To assemble the pan for use, the grasping portions of the panels and the bottom panel are first mated. The panels are next rotated to an upward position to form the pan. The panels are then locked into place. The assembled pan may then be used for baking or other suitable uses. The pan may be easily disassembled for cleaning and/or storage.

In the cooking and baking world presentation is almost as important as taste. Although there are many cooks and bakers which can produce great creations in the kitchen, many of these cooks and bakers have difficulty in removing their creations from the pan. Often, the bottom and/or edges of the dish or baked goods cannot be removed from the pan in a crisp manner. Inventions have been made in an attempt to solve this problem.

Prior art U.S. Pat. No. 428,792, issued May 27, 1890 to Willey, is for a baking tin or dish that is provided with a loose or removable bottom and loose sides that fall away from the cake or bread when baked, leaving it on the bottom alone to cool. The side and the end pieces composing the dish are loosely attached to a wire in their bottom edge upon which they swing, and on which the bottom of the utensil rests. Another wire, sliding up and down around the outside of the dish, operates said pieces.

Prior art U.S. Pat. No. 3,828,966, issued Aug. 13, 1974 to Martin, puts forth a collapsible baking pan that has a disposable liner of aluminum foil. The pan can be collapsed to a substantially flat position for ease of storage.

Prior art U.S. Pat. No. 1,714,379, issued May 21, 1929 to Kratz, concerns a baking pan with removable sides and ends so that a cake or loaf baked in the pan can be easily removed therefrom, without damage to the baked item. The sides and ends of the pan can be quickly removed and replaced. A latch means is provided for fastening the sides and ends together in such a manner that none of the material placed in the pan will leak through the joints of the pan.

Prior art U.S. Pat. No. 6,505,809, issued Jan. 14, 2003 to Reed, provides an apparatus and method for shaping and molding material that has two side walls, two end walls, a bottom and at least one partition. The two side walls have grooves spaced at predetermined intervals on an inside surface for receiving a partition and a bottom ledge for retaining the bottom. The inside surface has a plurality of openings sized for receiving holding members and may have a variety of shapes. The bottom is shaped to mate with the shape of the inside surface of the side walls. The two end walls include locking mechanisms for holding the various components of the apparatus together.

Prior art U.S. Pat. No. 4,644,858, issued Feb. 24, 1987 to Liotto, depicts a dual-purpose baking pan assembly that is suitable for use in a conventional oven wherein the assembly as well as the food therein are exposed to a high-temperature atmosphere, and in a microwave oven wherein the atmosphere is close to ambient temperature and the assembly and the food are subjected to microwave energy. All components of the assembly are formed of a dielectric material unaffected by microwave energy and capable of withstanding high temperatures. The assembly is constituted by a circular base which fits into an annular groove formed in a cylindrical shell defined by a pair of complementary half-sections whose rear ends are hinged together by a removable pivot pin and whose front ends are joinable by a detachable clamp. Thus, after a food product is baked in the assembly, the shell thereof may be detached from the base to expose the food product without disrupting its structure.

Prior art U.S. Pat. No. 5,779,080, issued Jul. 14, 1998 to Corse, shows a multi-purpose baking pan that has a pan portion for holding batter. A pastry holder is included to allow the user to bake differently-shaped pastries which can be inserted into the pan portion. The pan portion has a rectangular bottom wall with two side walls which extend integrally in the same direction from the bottom wall along the opposite edges. There are two end members, located at the short sides of the rectangular bottom, each have a rod-like hinge pin. Rotating an end member, by grasping and raising the lower portion thereof, allows the user to slide out the pastry holder without damage to the pastries or to the user. The multi-purpose baking pan also has a cover to protect the pastries within the baking pan.

Prior art U.S. Pat. No. 4,773,320, issued Sep. 27, 1988 to Stock, discloses a baking pan similar to a conventional baking pan except that the pan has a removable end section. The end section can be used to close one end of the pan when the baked goods are in a pre-cooked condition to prevent batter or the like from leaking out of the pan. The end section can be readily removed when the baked goods are to be served so that every piece of the baked goods can be removed without deforming such piece of baked goods or breaking it into pieces which would destroy the aesthetic presentation thereof.

Prior art U.S. Pat. No. 4,446,982, issued May 8, 1984 to Corse, claims a multi-purpose baking pan that is formed from a bottom pan member which has a convex bottom surface and a pair of side members that have a number of pairs of spaced apart holes. First and second end pieces are adapted to mate with respective pairs of holes in the side members of the bottom pan portion to form a baking pan of predetermined size. Different sized baking pans may be formed with the same structure by moving one or both of said end pieces to different pairs of holes along the bottom pan portion. A cupcake holder or similar plate having a number of holes therein may be mounted within the baking pan. The bottom portion of the pan member has a convex shape to mate with the end pieces and form a batter tight fit.

Prior art U.S. Pat. No. 4,113,225, issued Sep. 12, 1978 to Corse, describes a baking pan that has a removable end portion that allows easy access to the baked goods after baking. The removable end portion may be used as a spatula to lift the baked goods from the baking pan with minimum damage of the baked goods due to sticking.

Prior art U.S. Pat. No. 3,580,484, issued May 25, 1971 to Schneider, provides a portion access pie plate that is designed for gaining access to a piece of pie without mutilation of the pie. The pie plate involves lines of weakening extending radially from the center of the pie plate, which define segments specifically through the rim and sides of the plate. The segmental sections of the sides and rim are hinged and depressible for exposing cut portions of pie and also have a lever action that lifts and loosens the pie, thereby facilitating extraction of pie portions without mutilation.

Additional inventions are also known which attempt to allow an individual to remove a food item from a pan in a manner which eliminates damage to the food. However, these inventions fail to perform the desired function in the manner described by the invention herein.

A need, therefore, exists for an improved foldable pan which is capable of solving the problems currently associated with removing a food item from a pan in a desired manner.

### SUMMARY OF THE INVENTION

The present invention generally relates to a foldable baking pan which is formed by locking four panels onto a bottom panel. Each of the panels have a grasping portion which mates with a corresponding portion on the underside of the bottom panel. To assemble the pan for use, the grasping portions of the panels and the bottom panel are first mated. The panels are next rotated to an upward position to form the pan. The panels are then locked into place. The assembled pan may then be used for baking or other suitable uses. The pan may be easily disassembled for cleaning and/or storage.

An advantage of the present invention is to provide a pan which allows a user to easily and neatly remove the food item from the pan.

An advantage of the present invention is to provide a pan which is easily cleaned.

Another advantage of the present invention is to provide a pan which is scratch resistant.

A further advantage of the present invention is to provide a pan which is dishwasher safe.

Yet another advantage of the present invention is to provide a pan which may be easily assembled and dissembled.

In the preferred embodiment, the foldable pan has a bottom panel having sides wherein at least two sides have a recessed grasping edge; a plurality of removable panels wherein each panel has a grasping portion which mates with the recessed grasping edge of the bottom panel; and a bent rod secured to at least two of the panels wherein the rod has a handle portion.

In an embodiment, the foldable pan further has a protruding bump located on at least two of the panels wherein the protruding bumps engage with a portion of the locking mechanism portion of the rod and hold the rod in place.

In another embodiment, the protruding bumps of the foldable pan hold the locking mechanism portion of the rod in place by friction.

In still another embodiment, the bent rod of the foldable pan may rotate with respect to the panels.

In yet another embodiment, the foldable pan is fabricated of a material which is dishwasher safe.

And in an embodiment, the bottom panel and the removable panels are made from a scratch resistant surface.

In still another embodiment, the bottom panel and the removable panels are coated with a non-stick coating.

In an embodiment, the assembled pan is resistant to leakage.

Yet in another embodiment, the foldable pan has a removable tray wherein the removable tray is placed on the bottom panel and wherein a food item is placed on the removable tray.

In an embodiment, the foldable pan has a protruding edge located on a side of at least two of the panels wherein the protruding edge covers at least a portion of a different panel.

And in another embodiment, the foldable pan has a locking mechanism portion located on the rod and wherein the locking mechanism secures at least two panels together.

In an embodiment, the foldable pan has a plurality of feet located on a bottom side of the bottom panel.

And in an embodiment, the foldable pan has a sealing gasket along the bottom panel and along at least one side of each of the side panels wherein the gaskets prevent leakage of liquids after all the side panels are secured onto the bottom panel.

In an embodiment, the foldable pan has a bottom panel having front, back and side edges; a plurality of removable panels wherein at least two of the panels have a sleeve extending from an edge of the panel wherein the sleeve is securable to one of the edges of the bottom panel; and a bent rod secured to at least one of the panels wherein the rod has a locking mechanism to secure at least two of the panels.

Still in another embodiment, the foldable pan has: a bottom panel having front, back and side edges; a plurality of removable panels wherein at least two of the panels have protrusions extending from an edge of the removable panels wherein the protrusions are securable into slots on the front, back and side edges of the bottom panel; and a bent rod secured to at least one of the panels wherein the rod has a locking mechanism to secure at least two of the panels.

And in an embodiment, the plurality of removable side panels may be placed on an underside of the bottom panel for storage.

For a more complete understanding of the above listed features and advantages of the foldable baking pan, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a perspective view of the pan in its useful form.

FIG. 2 illustrates an exploded view of the pan prior to assembly.

FIG. 3 illustrates a first and second position of the rod of the pan.

FIG. 4 illustrates a step by step progression of the assembly of the pan of the present invention.

FIG. 5 illustrates the foldable pan having a removable tray.

FIG. 6 illustrates the foldable pan wherein the pan is assembled by securing protrusion on side panels into slots on a bottom panel.

FIG. 7 illustrates an underside of a bottom panel wherein the panels may be placed for storage while the pan is not in use.

### DETAILED DESCRIPTION OF THE PREFERRED EMBODIMENTS

The present invention generally relates to a foldable baking pan which is formed by locking four side panels onto a bottom panel. The side panels portion which mates with a corresponding grasping portion on the underside of the bottom panel. To assemble the pan for use, the grasping portions of the side panels and bottom panels are mated and the side panels rotated to an upward position. The side panels are then locked into place. The assembled pan may then be used for baking or other suitable uses.

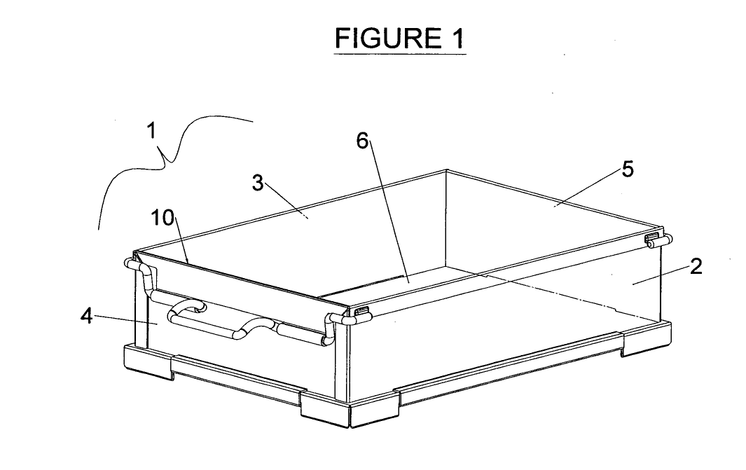

Referring now to the drawings wherein like numerals refer to like parts, FIG. 1 generally illustrates a pan 1 which may be disassembled. The pan 1 is particularly suitable for cooking, baking or otherwise preparing food. Preferably, the pan 1 is constructed from a sturdy material such as metal and is suitable for use in an oven and/or freezer. In an embodiment, the pan 1 may be constructed from a material which is microwave safe. Further, the pan 1 is preferably constructed from a material that is resistant to scratching and stains and also is coated with a non-stick material.

The pan 1 may have a first side panel 2, a second side panel 3, a front panel 4 and a back panel 5. Further, the pan 1 may have a bottom panel 6. All the panels of the pan 1 may be completely separated from each other for removal of a food item, cleaning and/or storage. The bottom panel 6 of the foldable pan 1 may be used as a serving tray after the side panels are removed or while the side panels are still secured to the bottom panel.

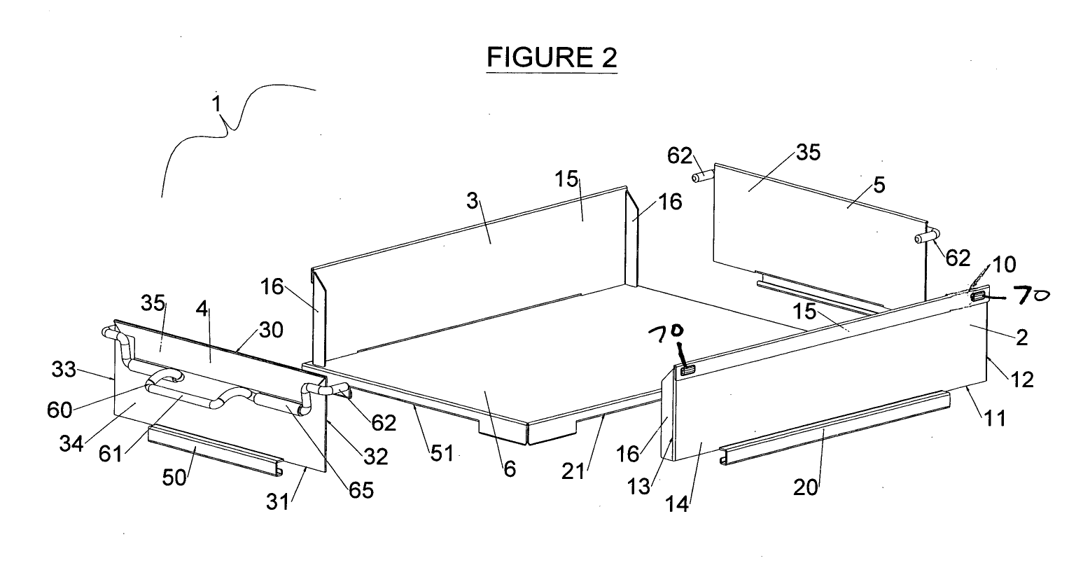

Referring now to FIG. 2, the first side panel 2 and the second side panel 3 may be mirror images of each other and may each have a top edge 10, a bottom edge 11, a first side 12, a second side 13, a front 14 and a back 15. The first side 12 and the second side 13 of the first side panel 2 may have a protruding edge 16. The protruding edge 16 of the first side 12 and the second side 13 of the first side panel 2 may allow the pan 1 to remain secure in the usable position (FIG. 1) and may also help make the pan 1 leak proof.

The bottom edge 11 of the first side panel 2 may have a grasping portion 20 generally in the shape of an elongated “u”. The grasping portion 20 may extend outwardly beyond the generally flat first side panel 2. The grasping portion 20 of the bottom edge 11 of the first side panel 2 may be secured to a corresponding recessed area 21 of the bottom panel 6 (as discussed below). Preferably, the length of the grasping portion 20 of the bottom edge 11 of the first side panel 2 is slightly less than the length of the corresponding recessed area 21 of the bottom panel 6.

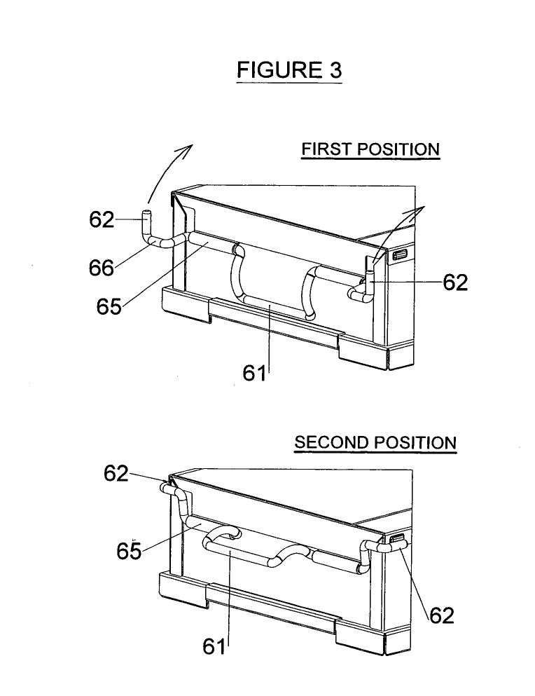

The front panel 4 and the back panel 5 may be mirror images of each other and may each have a top edge 30, a bottom edge 31, a first side 32, a second side 33, a front 34 and a back 35. The bottom edge 31 of the front panel 4 may have a grasping portion 50 similar to the grasping portion 20 of the first side panel 2 and second side panel 3 which mates with a corresponding recessed portion 51 of the bottom panel 6 (as disclosed below). Preferably, the length of the grasping portion 50 of the bottom edge 31 of the front panel 4 and back panel 5 is slightly less than the length of the corresponding recessed area 51 of the bottom panel 6. The front panel 4 and back panel 5 may also have a bent rod 60 which may have both a handle portion 61 and a locking mechanism portion 62. The rod 60 may be attached to the front 34 of the front panel 4 by, for example, a securing mechanism 65. The securing mechanism 65 may allow the rod 60 to rotate from a first position 66 to a second position 67 (see FIG. 3).

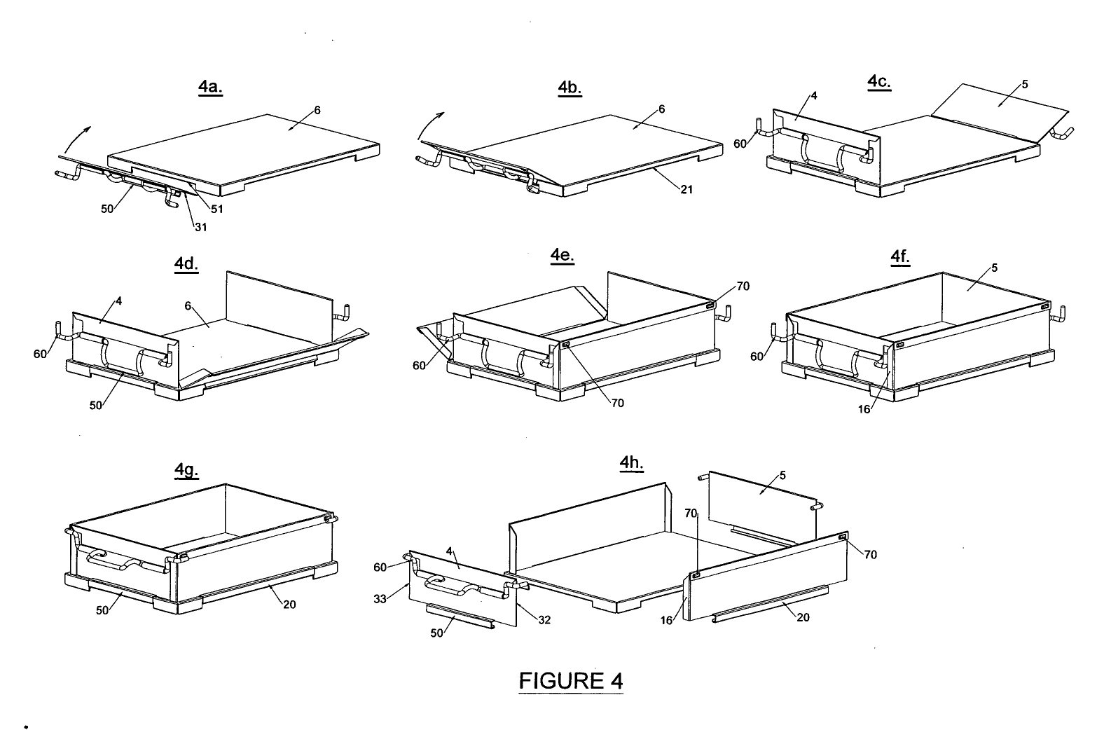

Referring now to FIG. 4, to assemble the pan 1 into the usable condition the grasping portion 50 of the bottom edge 31 of the front panel 4 and the back panel 5 are inserted into the corresponding recessed portion 51 of the bottom panel 6. Because of the elongated “u” shape of both the grasping portion 50 and the corresponding recessed portion 51 it may be necessary to place the front panel 4 and back panel 5 in a position so that the back 35 of the front panel 4 and the back panel 5 are somewhat parallel to the bottom panel 6 of the pan 1. After the grasping portion 50 is secured into the corresponding recessed area 51 the front panel 4 and the back panel 5 may be rotated approximately 90 degrees upward (to a substantially perpendicular position with respect to the bottom panel 6). The grasping portion 20 of the bottom edge 11 of the first side panel 2 and second side panel 3 may then be secured to the corresponding recessed area 21 of the bottom panel 6 in a similar fashion as the front panel 4 and back panel 5. After the grasping portion 20 is secured in the corresponding recessed area 21 the first side panel 2 and second side panel 3 may likewise be rotated approximately 90 degrees upward (to a substantially perpendicular position) from a substantially parallel position with respect to the bottom panel 6. In the useful position (FIG. 1), the back 15 of the first side panel 2, the back 15 of the second side panel 3, the back 35 of the front panel 4 and the back 35 of the back panel 5 all face the interior of the pan 1. Alternatively, the sides may placed on the bottom panel 6 before the front panel 4 and back panel 5 are placed onto the bottom panel 6.

The protruding edge 16 of the first side 12 and the second side 13 of the first side panel 2 and second side panel 3 may cover a portion of the first side 32 and second side 33 of the front panel 4 and the back panel 5. More specifically, the protruding edge 16 may wrap around a portion of the front panel 4 and back panel 5 and may help secure the front panel and back panel 5 onto the bottom panel 6. Further, the protruding edge 16 may also help reduce leakage by liquids that may be placed into the pan 1. Alternatively, the protruding edge 16 may be located on the front panel 4 and back panel 5.

The rod(s) 60 of the pan 1 may rotate from a first position to a second position. In the first position, the handle portion 61 and the locking mechanism portion 62 of the rod 60 are largely parallel to the front panel 4 and back panel 5. In this first position the first side panel 2 and the second side panel 3 are not secured to the pan 1. More specifically, in this first position the first side panel 2 and the second side panel 3 may be rotated around the grasping portion 20 and, therefore, the panels may rotate from a position substantially perpendicular to the bottom panel 6 to a position substantially parallel to the bottom panel 6. Further, the first side panel 2 and the second side panel 3 may then be removed from the bottom panel 6 and washed and or stored for later use.

To secure the first side panel 2 and the second side panel 3 onto the bottom panel 6, the rod(s) 60 are preferably placed into a second position. To secure the rod(s) 60 into the second position, the rod(s) 60 are preferably rotated approximately 90 degrees so that the handle portion 61 and the locking mechanism portion 62 are substantially perpendicular to the front panel 4 and the back panel 5. In this second position, the locking mechanism portion 62 extends over a portion of the sides of the first side panel 2 and the second side panel 3. As a result, the first side panel 2 and second side panel 3 are prevented from moving. Further, a bump 70 may be present near the first side 12 and the second side 13 of the first side panel 2 and second side panel 3. The bump 70 may prevent the locking mechanism portion 62 of the rod(s) 60 from inadvertently moving and allowing the rod(s) 60 to inadvertently rotate to the first (unsecured) position. The bump 70 may hold the locking mechanism portion 62 in place by, for example, friction. Obviously, the length of the rod(s) 60 must be greater than the length of the front panel 4 and the back panel 5 so that the locking mechanism portion 62 may be rotated into the second position.

Once secured into the locked second position, the pan 1 may be filled with food items and cooked, baked, frozen or otherwise used in the preparation of food. After use, the pan 1 is unlocked and the panels removed. The food item is then easily exposed for consumption or further preparation. Finally, the panels of the pan 1 may be easily washed and/or stored for future use.

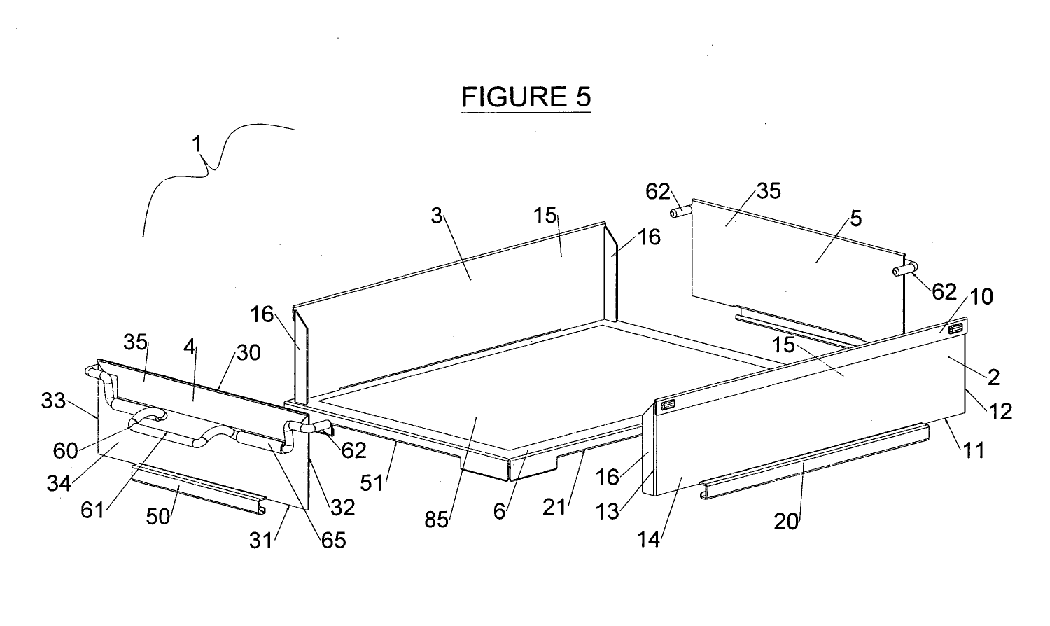

Referring now to FIG. 5, in an embodiment, the pan 1 may have a removable tray 85. The removable tray 85 may be placed on the top side of the bottom panel 6 while the pan 1 is in use. The food item may be placed directly on top of the removable tray 85, so as to prevent the food item from direct contact with the bottom panel 6. After the food item is prepared, the removable tray 85 may be removed from the pan 1 with the food item. As a result, the foot item may be served directly on the removable tray 85 or served on an alternative surface. Preparing the food item on the removable tray 85 may make cleaning the pan 1 much easier. The user may then simply wash the removable tray 85 and store the pan 1. Preferably, the removable tray 85 is substantially the same size as the bottom panel 6 of the pan 1 so that little or no food may directly contact the bottom panel 6 of the pan 1. In order to remove the removable tray 85 from the pan 1, the user may be required to remove some or all of the four panels.

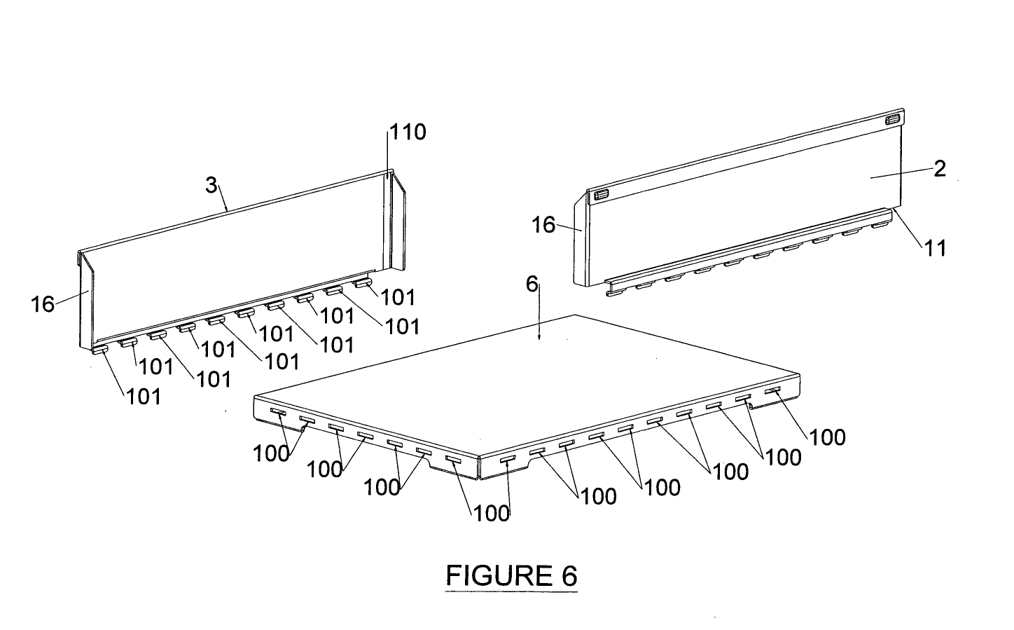

Referring now to FIG. 6, in an embodiment, bottom panel 6 of the pan 1 may have four sides. Each of the sides of the bottom panel 6 may have a plurality of slots 100. Further, the first side panel 2, the second side panel 3, the front panel 4 and the back panel 5 may each have a plurality of protrusions 101 which may be inserted into the plurality of slots 100 located on the bottom panel 6. In this embodiment, the side panels are secured to the bottom panel 6 by means of securing the protrusions 101 into the slots 100 as opposed to securing the grasping portion (50 or 20) into the recessed area (51 or 21) as disclosed in FIGS. 1-5. The number of protrusions 101 and corresponding slots 100 present on the side panels and bottom panel 6 may vary according to, for example, obtaining a desired look, obtaining a desired strength, obtaining a desired easy in cleaning.

To secure the side panels onto the bottom panel 6, the user may first insert the plurality of protrusions 101 of the front panel 4 or back panel 5 into the corresponding mating slots 100 on the front or back of the bottom panel 6. Preferably, the protrusions 101 are formed with a bend so as the user must insert the protrusions 101 into the slots 100 on an angle and then rotate the front panel 4 and back panel 5 upward to a substantially ninety degree angle with respect to the bottom panel 6. As a result of the bend in the protrusions 101 on the front panel 4 and side panel 5, the front panel 4 and side panel 5 may more easily be temporarily secured onto the bottom panel 6 and the assembled pan 1 may maintain an increased strength. After the front panel 4 and back panel 5 are secured onto the bottom panel 6, the first side panel 2 and second side panel 3 may be secured into the bottom panel 6 in much the same way as the front panel 4 and back panel 5.

FIG. 6 also illustrates an embodiment of the foldable pan 1 wherein a gasket 110 is present. The gasket 110 may help prevent unintentional leakage of any of the food items placed into the foldable pan 1 during preparation of the food item. The gasket 110 is preferable constructed from a durable rubber or plastic; however, any suitable material (including metal) may be used to accomplish this function.

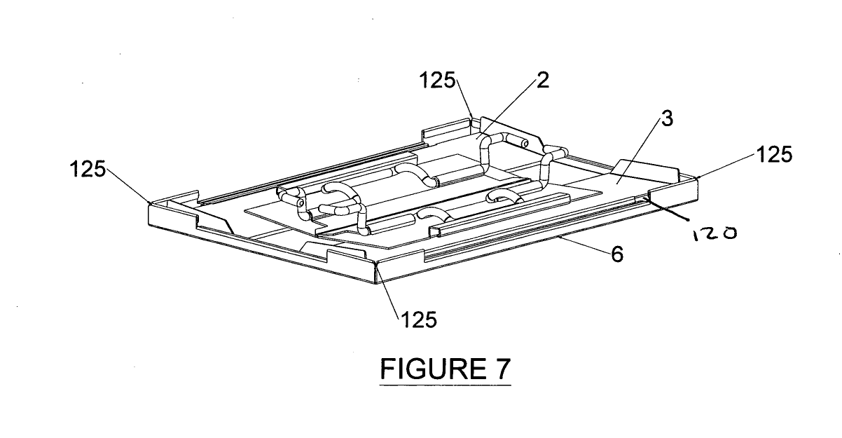

Referring now to FIG. 7, an underside 120 of the bottom panel 6 is illustrated. The underside 120 of the bottom panel 6 may also have a plurality of feet 125. The feet 125 are preferably located at or near the coroners of the bottom panel 6 and may be used to stabilize the foldable pan 1 and prevent the foldable pan 1 from scratching and/or damaging a countertop, table or the like while the foldable pan 1 is in an upright position. The feet 125 of the bottom panel 6 are preferably constructed of rubber or plastic, but may be made of any suitable material. After the four side panels are removed from the bottom panel 6, the side panels may be placed on the underside 120 of the bottom panel 6 for storage.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

I claim:

1) A foldable pan comprising:
a bottom panel having sides wherein at least two sides have a recessed grasping edge;
a plurality of removable panels wherein each panel has a grasping portion which mates with the recessed grasping edge of the bottom panel; and
a bent rod secured to at least two of the panels wherein the rod has a handle portion.

2) The foldable pan of claim 1 further comprising:
a protruding bump located on at least two of the panels wherein the protruding bumps engage with a portion of the locking mechanism portion of the rod and hold the rod in place.

3) The foldable pan of claim 2 wherein the protruding bumps hold the locking mechanism portion of the rod in place by friction.

4) The foldable pan of claim 1 wherein the bent rod may rotate with respect to the panels.

5) The foldable pan of claim 1 wherein the pan is fabricated of a material which is dishwasher safe.

6) The foldable pan of claim 1 wherein the bottom panel and the removable panels are made from a scratch resistant surface.

7) The foldable pan of claim 1 wherein the bottom panel and the removable panels are coated with a non-stick coating.

8) The foldable pan of claim 1 wherein the assembled pan is resistant to leakage.

9) The foldable pan of claim 1 further comprising;
a removable tray wherein the removable tray is placed on the bottom panel and wherein a food item is placed on the removable tray.

10) The foldable pan of claim 1 further comprising:
a protruding edge located on a side of at least two of the panels wherein the protruding edge covers at least a portion of a different panel.

11) The foldable pan of claim 1 further comprising:
a locking mechanism portion located on the rod and wherein the locking mechanism secures at least two panels together.

12) The foldable pan of claim 1 further comprising:
a plurality of feet located on a bottom side of the bottom panel.

13) The foldable pan of claim 1 further comprising:
a sealing gasket along the bottom panel and along at least one side of each of the side panels wherein the gaskets prevent leakage of liquids after all the side panels are secured onto the bottom panel.

14) A foldable pan comprising:
a bottom panel having front, back and side edges;
a plurality of removable panels wherein at least two of the panels have a sleeve extending from an edge of the panel wherein the sleeve is securable to one of the edges of the bottom panel; and
a bent rod secured to at least one of the panels wherein the rod has a locking mechanism to secure at least two of the panels.

15) A foldable pan comprising:
a bottom panel having front, back and side edges;
a plurality of removable panels wherein at least two of the panels have protrusions extending from an edge of the removable panels wherein the protrusions are securable into slots on the front, back and side edges of the bottom panel; and
a bent rod secured to at least one of the panels wherein the rod has a locking mechanism to secure at least two of the panels.

16) The foldable pan of claim 15 wherein the plurality of removable side panels may be placed on an underside of the bottom panel for storage.
